(19) United States
(12) Patent Application Publication
(10) Pub. No.: US 2025/0333272 A1
(43) Pub. Date: Oct. 30, 2025

(54) JIB ASSEMBLY AND A METHOD OF OPERATION THEREOF

(71) Applicant: Two Harbors Machine Shop Inc., Two Harbors, MN (US)

(72) Inventors: Charles-Étienne Simard, Victoriaville (CA); Karl Johnson, Duluth, MN (US); Jean-Claude Perreault, St-Lambert (CA); Derek Peters, Two Harbors, MN (US); Matthew Robertson, Duluth, MN (US)

(73) Assignee: Two Harbors Machine Shop Inc., Two Harbors, MN (US)

(21) Appl. No.: 18/750,094

(22) Filed: Jun. 21, 2024

(30) Foreign Application Priority Data
Apr. 29, 2024 (CA) 3236760

(51) Int. Cl. B66C 23/68; B66C 23/66; B66C 23/70

(52) U.S. Cl. CPC B66C 23/68; B66C 23/66; B66C 23/703

(57) ABSTRACT

A jib assembly and a method of operating a jib assembly are provided. The jib assembly comprises: an outer section having a hollow outer body; a middle section having a hollow middle body and positioned coaxially with the outer section and located partially inside the outer section; an inner section having a hollow inner body and positioned coaxially with the middle section, and located partially inside the middle section; and a stroke cylinder having a cylinder base and a piston end, the cylinder base of the stroke cylinder being connected to a base wall of the outer section and the piston end being connected to a tip portion of the inner section, and the stroke cylinder being configured to move simultaneously the inner section from inside of the middle section and to move the middle section from inside of the outer section.

### CROSS-REFERENCE TO RELATED APPLICATIONS

This application claims priority to Canadian Patent Application No. 3236760 filed Apr. 29, 2024 of the same title, which is assigned to the assignee hereof and hereby incorporated by reference.

### TECHNICAL FIELD

The present disclosure relates to knuckle boom loaders. More specifically, the present disclosure relates to jibs and their extensions for the knuckle boom loaders.

### BACKGROUND

Knuckle boom loaders allow for lifting and manipulation of heavy loads with a grapple and may be used in various industries, such as, for example, forestry, railroad maintenance, storm clean-up services.

A typical knuckle boom loader has a boom and a jib. Some known loaders have, in addition to the jib, a jib extension which allows the grapple, located at a tip of the jib extension, to reach further than the jib and to manipulate the loads. However, the jibs that known in the art are heavy and need to be improved.

### SUMMARY

It is an object of the present disclosure to provide a jib assembly for a knuckle boom loader. According to one aspect of the disclosed technology, there is provided a jib assembly. According to one aspect of the disclosed technology, there is provided a method for operating of the jib assembly.

The jib assembly comprises: an outer section having a hollow outer body; a middle section having a hollow middle body and positioned coaxially with the outer section and located partially inside the outer section; an inner section having a hollow inner body and positioned coaxially with the middle section, and located partially inside the middle section; and a stroke cylinder having a cylinder base and a piston end, the cylinder base of the stroke cylinder being connected to a base wall of the outer section and the piston end being connected to a tip portion of the inner section, and the stroke cylinder being configured to move simultaneously the inner section from inside of the middle section and to move the middle section from inside of the outer section.

In at least one embodiment, the stroke cylinder is operated by a regeneration valve located on an outer external surface of the outer section, the regeneration valve being connected to the stroke cylinder via a first tube and a second tube.

The stroke cylinder may be operated by a regeneration valve attached directly to the stroke cylinder. The stroke cylinder may be integral to cylinder hydraulic ports.

In at least one embodiment, the jib assembly is configured to be operated by a hydraulic regenerative valve operated by a main control valve. The piston end may be connected to the tip portion of the inner section using a piston pin positioned perpendicular to the stroke cylinder. The jib assembly may further comprise a pair of hose rollers removably attached inside the middle section to each one of two opposite middle section side walls, the hose rollers being configured to roll hoses into the inner section and the middle section when the jib assembly extends and retracts, and, in at least one embodiment, a distance between hydraulic return manifolds, the hose rollers, and a sliding tensioner bulkhead plate attached to the inner section remains constant during operation of the jib assembly. The jib assembly may comprise a pair of hose rollers removably attached inside the middle section to each one of two opposite middle section side walls, the hose rollers being configured to roll hoses into the inner section and the middle section when the jib assembly extends and retracts, and a sum of a first distance and a second distance remains constant during operation (extension and retraction) of the jib assembly, the first distance being between hydraulic return manifolds and the hose rollers, and the second distance being between the hose rollers and a sliding tensioner bulkhead plate. The jib assembly may further comprise outer tubes attached to the outer external surface of the outer body and to a tensioner bulkhead block; and inner hoses attached to the tensioner bulkhead block on the other side and then extend inside the outer section, between the outer section and the middle section to attach to a tip portion of the inner section.

The jib assembly may further comprise a timing chain removably attached to the outer section and to an extreme external surface of the inner section, such that, when the stroke cylinder is activated, and the stroke cylinder extends the inner section and the middle section from the outer section, the timing chain synchronizes simultaneous extension of the inner section and the middle section from the outer section. The timing chain may pass through chain apertures in the middle section to extend inside and outside of the middle section along one side of the middle section. The timing chain may be attached to a chain attachment block removably attached to the outer section.

The jib assembly may further comprise chain rollers attached to the middle section and configured to assist rolling of the timing chain. Cross-sections of the outer section, the middle section and the inner section may be rectangular. The outer section, the middle section and the inner section each may be made of two sheets of material and may have two weld joints. The jib assembly may further comprise a plurality of outer wear pads positioned between the outer section and the middle section and a plurality of inner wear pads positioned between the inner section and the middle section. The outer wear pads and the inner wear pads may be impregnated with a lubricator and may be impact resistant. The outer wear pads may be located in recesses located in outer slider pad trays attached to sides of the outer section, and the inner wear pads may be located in other recesses in inner slider pad trays attached to sides of the middle section.

According to another aspect of the disclosed technology, there is provided a knuckle boom loader comprising the jib assembly as described herein.

According to another aspect of the disclosed technology, there is provided a method comprising: by operating a regenerative valve, extending a stroke cylinder inside a jib assembly and simultaneously extending a middle section out of an outer section of a jib assembly and an inner section out of the middle section. In at least one embodiment, the extension of the middle section out of the outer section of the jib assembly and the inner section out of the middle section is timed by a timing chain extending inside and outside of the middle section, the timing chain being attached to the outer section. According to another aspect of the disclosed technology, there is provided a method comprising: by operating a regenerative valve, retracting a stroke cylinder inside a jib assembly and simultaneously retracting a middle section into an outer section of the jib assembly and an inner section into the middle section. In at least one embodiment, the retraction of the middle section into the outer section of the jib assembly and the inner section into the middle section is timed by a timing chain extending inside and outside of the middle section, the timing chain being attached to the outer section.

A jib assembly and a method of operating a jib assembly are provided herein. The jib assembly comprises: an outer section having a hollow outer body; a middle section having a hollow middle body and positioned coaxially with the outer section and located partially inside the outer section; an inner section having a hollow inner body and positioned coaxially with the middle section, and located partially inside the middle section; and a stroke cylinder having a cylinder base and a piston end, the cylinder base of the stroke cylinder being connected to a base wall of the outer section and the piston end being connected to a tip portion of the inner section, and the stroke cylinder being configured to move simultaneously the inner section from inside of the middle section and to move the middle section from inside of the outer section.

### BRIEF DESCRIPTION OF THE DRAWINGS

Further features and advantages of the present disclosure will become apparent from the following detailed description, taken in combination with the appended drawings, in which:

FIG. 1 illustrates a knuckle boom loader in a retracted position (also referred to herein as a “closed position”), in accordance with at least one embodiment of the present disclosure;

FIG. 2 illustrates the knuckle boom loader of FIG. 1 in an extended position (also referred to herein as an “open position”), in accordance with at least one embodiment of the present disclosure;

FIG. 3 is an exploded view of a jib assembly of the knuckle boom loader of FIG. 1, in accordance with at least one embodiment of the present disclosure;

FIG. 4A is a partial exploded view of an outer section, a middle section and an inner section of the jib assembly of FIG. 3, in accordance with at least one embodiment of the present disclosure;

FIG. 4B is an exploded view of a stroke cylinder of the jib assembly of FIG. 3, in accordance with at least one embodiment of the present disclosure;

FIG. 5 is a partial cross-sectional view of a portion of the jib assembly of FIG. 3;

FIG. 6 is a perspective view of the jib assembly of FIG. 3;

FIG. 7A illustrates a partially exploded perspective view of another portion of the jib assembly of FIG. 3, in accordance with at least one embodiment;

FIG. 7B illustrates a partial cross-sectional view of the jib assembly of FIG. 3 in the retracted position, in accordance with at least one embodiment;

FIG. 7C illustrates a partial cross-sectional view of the jib assembly of FIG. 3 in the extended position, in accordance with at least one embodiment;

FIG. 7D illustrates an enlarged portion of FIG. 7C, depicting the timing chain;

FIG. 8A illustrates a partially exploded perspective view of another portion of the jib assembly of FIG. 3;

FIG. 8B illustrates a perspective view of the portion of the jib assembly of FIG. 8A

FIG. 8C illustrates a portion of the middle section and the inner section of the jib assembly of FIG. 3, in accordance with at least one embodiment;

FIG. 9 illustrates an exploded view of a managing assembly for operation of the knuckle boom loader with the jib assembly of FIG. 3; and

FIG. 10 illustrates a method of operation of the jib assembly, in accordance with at least one embodiment.

It will be noted that throughout the appended drawings, like features are identified by like reference numerals.

### DETAILED DESCRIPTION

Various aspects of the present disclosure generally address one or more of the problems of improving and increasing the reach of the knuckle boom loader.

United States patent No. U.S. Pat. No. 9,718,655 B2 describes a hydraulically actuatable jib for a loading crane which includes at least two jib extensions, the first jib extension being designed as an outer jib extension and the second jib extension being designed as an inner jib extension. At least two feed cylinders extend and react the at least two jib extensions. A hydraulic circuit for a working fluid includes a retraction line for retracting the feed cylinders in a pressurized manner, and the retraction line opens into the feed cylinder of the outer jib extension. A tank is provided for releasing the working fluid, and a control valve can be switched into an open position when the outer jib extension reaches a defined retraction position, particularly when the outer jib extension is substantially fully retracted. The valve thereby supplies the feed cylinder of the inner jib extension with pressurized working fluid. However, such a hydraulically actuatable jib operates using at least two feed cylinders which slows down the operation. Jibs having more than one hydraulic cylinder are heavy, have many components in hydraulic cylinders and pins, and require more hydraulic oil and multiple valve controls.

Some hydraulically actuatable jibs known in the art may have one cylinder with a heavy-duty chain, where the heavy-duty chain carries the full load instead of the cylinder, making such jib structures activated by mechanics and not by hydraulics. The heavy-duty chain and internal hydraulic hoses, if present, in such prior art jibs require complex assembly and maintenance.

The present description provides a jib assembly and a method of operation thereof that increases the reach of the knuckle boom loader. In addition, due to the use of the hydraulic regeneration valve as described herein, the jib assembly as described herein may be operated faster (have higher jib extension speeds) than known jib assemblies. Due to the use of external grapple tubes in construction, the jib assembly as described herein allows for easier access to the internal components. The construction of the jib assembly also allows for reducing a cross section of the boom while maintaining strength and low cost. In addition, due to self-lubrication of the components, such as, for example, wearing pads, the service life of the components may be extended.

The grapple loaders with the jib assembly as described herein allow to effectively move debris and other garbage to the landfill faster than traditional disposal methods. Such grapple loaders may be used, for example, for storm and disaster clean-up.

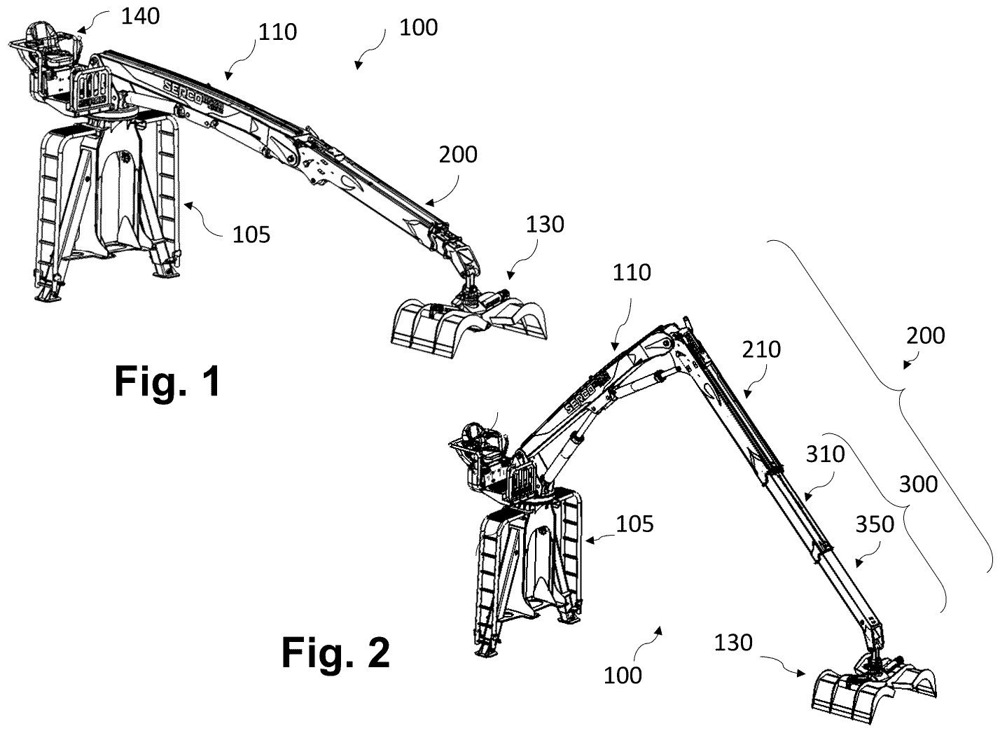

Referring now to the drawings, FIG. 1 illustrates a knuckle boom loader 100 in a retracted position, in accordance with at least one embodiment of the present disclosure. FIG. 2 illustrates the boom loader 100 of FIG. 1 in an extended position, in accordance with at least one embodiment of the present disclosure. The boom loader 100 has a boom support 105, a boom 110, a jib assembly 200, a grapple 130, and a managing assembly 140.

The jib assembly 200 has an outer section 210, a middle section 310 and an inner section 350. The middle section 310 and the inner section 350 form a jib extension 300. The inner section 350 is connected to the grapple 130.

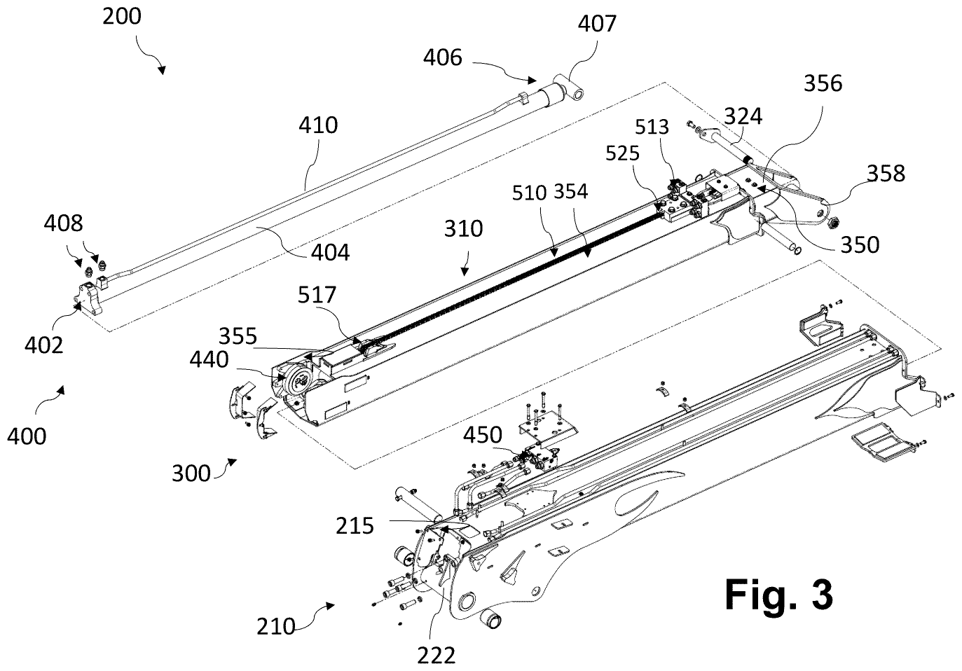

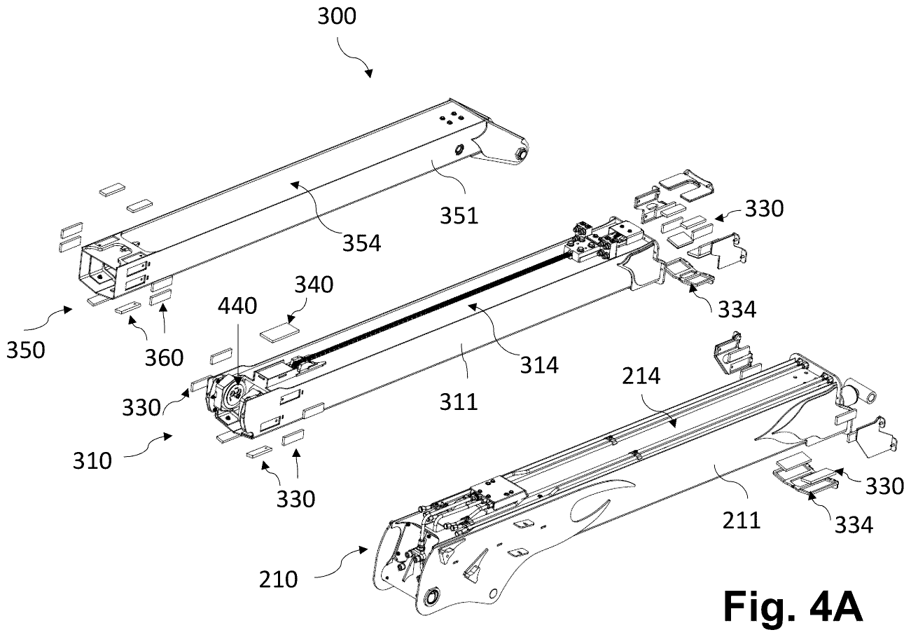

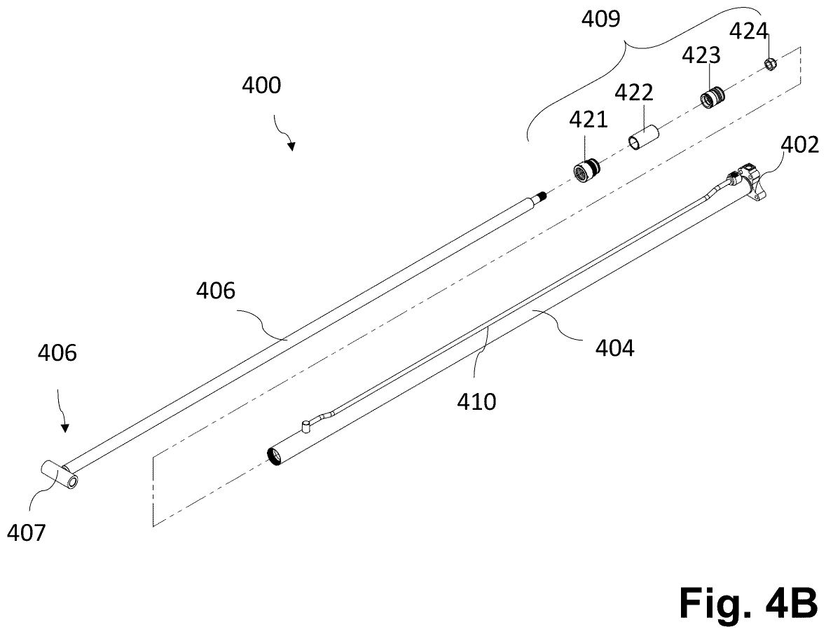

FIG. 3 is an exploded view of the jib assembly 200, in accordance with at least one embodiment of the present disclosure. FIG. 4A is an exploded view of the outer section 210, the middle section 310, the inner section 350 of the jib assembly 200 of FIG. 3, in accordance with at least one embodiment of the present disclosure.

As can be seen in the drawings, each one of the outer section 210, the middle section 310, and the inner section 350 has its own corresponding body (referred to herein as an “outer body 211”, a “middle body 311”, and the “inner body 351”), each having a shape of a hollow cylinder which are positioned co-axially with respect to each other. When the jib assembly 200 is in its retracted position and its extended position, the inner body 351 is located at least partially within the middle body 311, and the middle body 311 is located at least partially within the outer body 211. In at least one embodiment, cross-sections of the outer section 210, the middle section 310 and the inner section 350 are rectangular, while other forms of the cross-sections of the sections 210, 310, 350 may be also possible.

The inner section 350 has a tip portion 356 connected to a grapple connector 358 that can hold the grapple 130 illustrated in FIG. 1.

The jib extension assembly 200 as described herein also has one stroke cylinder 400. The stroke cylinder 400 is located inside the inner section 350 and is attached to the outer section 210 and to the inner section 350. The stroke cylinder 400 is configured to assist the jib assembly 200 to extend (in other words, to execute an extension operation) to the extended state illustrated, for example, in FIG. 2 and to retract (in other words, to execute a retraction operation) illustrated, for example, in FIG. 1.

As depicted in FIG. 3 and FIG. 4B, the cylinder 400 has a cylinder base 402, a cylinder sleeve 404, a piston rod 406 having a piston end 407, and a feeding tube 410 attached to the cylinder sleeve 404. FIG. 4B depicts an exploded view of the stroke cylinder 400 of the jib assembly 200, in accordance with at least one embodiment of the present disclosure. A piston head 409 has a gland 421, a tube stopper 422, a nut stover 423, and a ring cushion 424 (which may be cast made).

The feeding tube 410 is extended along the cylinder sleeve 404 from the vicinity of the piston end 407 outside of the cylinder sleeve 404 and is attached to the cylinder sleeve 404 in the vicinity of the cylinder base 402.

The diameter (the transverse diameter) of the piston rod 406 defines the “rod diameter”, while the diameter (the transverse diameter) of the piston head 409 defines the “bore diameter”. The values of the bore diameter, rod diameter, and their respective ratio (so-called “bore to rod diameter ratio”) define the speed of extension (in other words, the speed of executing an extension operation of the jib assembly 200) and the lifting power of the jib assembly 200, as described below.

In at least one embodiment, an optimized “bore to rod diameter ratio” of the stroke cylinder 400 may be used to maintain the speed of extension and, at the same time, the lifting power of the jib assembly 200. To optimize the diameters of the bore and the rod, the following considerations need to be taken into account: for fastest speed of operation, the bore diameter needs to be smaller while still providing an adequate force (in other words, the adequate lifting power for the use of the jib assembly 200). To increase the retracting speed, while still allowing for the adequate force (lifting power), the rod diameter needs to be increased. For example, the ranges of the bore and the rod diameters that would allow for higher operation speed with higher lifting power may be: the bore diameter may be between 2.25 inches and 3.00 inches, while the rod diameter may be between 1.63 inches and 2.00.

For example, the bore diameter may be 2.75 inches while the rod diameter may be 2.00 inches which may provide, according to the estimations, the cycle time of 6.8 seconds and retracting force of approximately 7000 pounds (lb). For example, when the bore diameter is 2.25 inches and the rod diameter is 1.63 inches, the cycle time may be estimated to be 4.6 seconds with the retraction force of approximately 4700 lb. For example, when the bore diameter is 3.00 inches and the rod diameter is 2.00 inches, the cycle time may be estimated to be 7.6 seconds with the retraction force of approximately 9800 lb.

The stroke cylinder 400 as described herein is longer compared to the prior art systems. The length of the stroke cylinder 400 may be defined by the desired length of the jib extension assembly 200 in the extended position. For example, the length of the stroke cylinder 400 may be, for example, between 6 feet to 11 feet (1.8288 meters to 3.3528 meters). For a non-limiting example, the length of the stroke cylinder 400 may be 56 inches (1.4 meters) longer than a standard extension cylinder. For example, the standard (prior art) cylinders may have a stoke length (defined as a difference between a fully extended cylinder and fully retracted cylinder) between 36 inches and 48 inches (between 0.9 meters and 1.2 meters). In some embodiments, the stroke cylinder 400 as described herein may have a stroke length between 100 inches (2.54 meters) and 110 inches (2.8 meters), between 2.6 meters and 2.7 meters, for example, 104 inches (2.6416 meters).

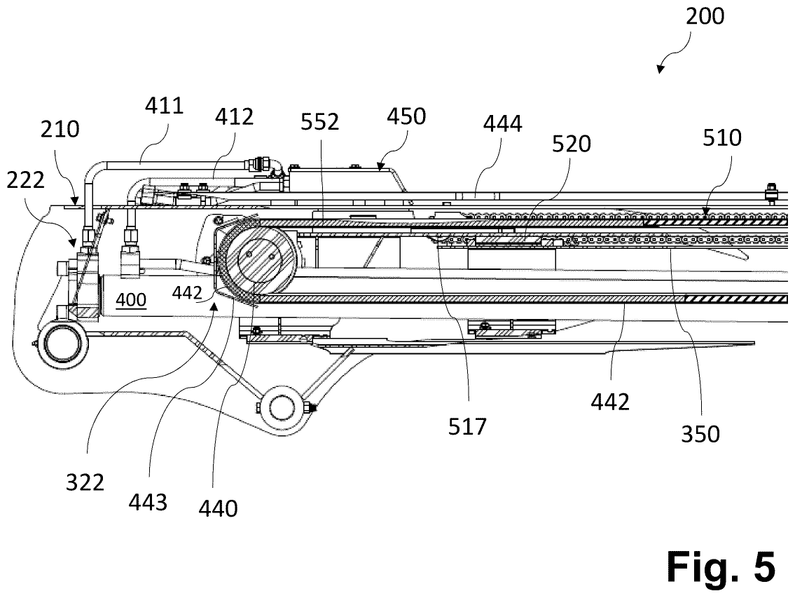

FIG. 5 depicts a partial cross-sectional view of a portion of the jib assembly 200. Referring to FIGS. 3, 4B, 5, the feeding tubes 410 and the cylinder base 402 are connected, via adapters 408, to a first tube 411, and a second tube 412 connected to a regeneration valve 450. In at least one embodiment, the first and second tubes 411, 412, that are used to operate the cylinder 400, pass through at least one aperture in the outer body 211 of the outer section 210 to operably connect with the regeneration valve 450, which is attached to the extreme external surface 354 of the outer section 210.

In at least one embodiment, the regeneration valve 450 is constantly (during the operation of the knuckle boom loader 100) in the actuated mode, so that the stroke cylinder 400 is constantly in the regeneration mode. To obtain optimal speed and power of the stroke cylinder 400, the bore and rod diameters of the stroke cylinder 400 may be chosen as described above. In at least one embodiment, the stroke cylinder 400 is operated by the regeneration valve 450 located on an outer external surface of the outer section 210, the regeneration valve 450 being connected to the stroke cylinder 400 via a first tube 411 and a second tube 412. The stroke cylinder 400 may be operated by the regeneration valve 450 attached directly to the stroke cylinder 400 or when it is integral to cylinder hydraulic ports.

When the jib assembly 200 is retracted, there is a gap between the base end 322 of the middle section 310 and the base wall 222 (see FIG. 5). The cylinder 400 is located inside the inner body 351 of the inner section 350 and a portion of the cylinder 400 extends beyond the inner section 350 and the middle section 310 into the gap between the base end 322 and the base wall 222. The cylinder base 402 of the cylinder 400 is attached to the base wall 222 of the outer section 210.

The piston end 407 is removably attached to the inner section via a piston pin 324 which is configured to pass through an orifice of the piston end 407. Thus, when all the sections of the jib assembly 200 are fully extended, and therefore the jib assembly 200 is in its extended position (as illustrated, for example, in FIG. 2), the cylinder 400 is extended inside the jib assembly 200 thus extending between the base wall 222 of the outer section 210 and the tip portion 356 of the inner section 350.

The stroke cylinder 400 is a long stroke cylinder, having the cylinder base 402 connected to the base wall 222 of the outer section 210, and having the piston end 407 connected to the inner section 350. The piston end 407 is connected to the tip portion 356 of the inner section 350 using the piston pin 324 positioned perpendicular to the stroke cylinder 400. While the regenerative valve 450 is always actuated, when the cylinder 400 is activated by the regenerative valve 450, the cylinder 400 moves (displaces) simultaneously the inner section 350 and the middle section 310 partially and further out from the inside of the outer section 210, while the middle section 310 is moved further out of the outer section 210, thus extending the jib assembly 200 and therefore increasing the length of the jib assembly 200. In other words, the stroke cylinder 400 is configured to move simultaneously the inner section 350 from the inside of the middle section 310 and to move the middle section 310 from inside of the outer section 210. Similarly, the cylinder 400 moves (displaces) the inner section 350 and the middle section 310 partially inside the outer section 210, while the middle section 310 is moved into the outer section 210, thus retracting the jib assembly 200 and therefore shortening the length of the jib assembly 200. In other words, the stroke cylinder 400 is configured to move simultaneously the inner section 350 into the middle section 310 and to move the middle section 310 into the outer section 210.

Having just one cylinder 400 that, when activated, moves out both inner section 350 and middle section 310 simultaneously to extend the jib assembly 200 allows for faster and longer reach, compared to the prior art extension that would need activation of more than one cylinders to extend the jib. In addition, the cylinder 400 as described herein does not require any heavy-duty chain because the chain in the jib assembly 200 described herein below does not need to carry the full load.

As illustrated in FIGS. 3-5, hose rollers 440 are located at each one of two opposite side walls of the middle section 310 (also referred to herein as “middle section side walls”). The hose rollers 440 are attached to the internal surfaces 355 of the middle section 310 (as illustrated in FIG. 3).

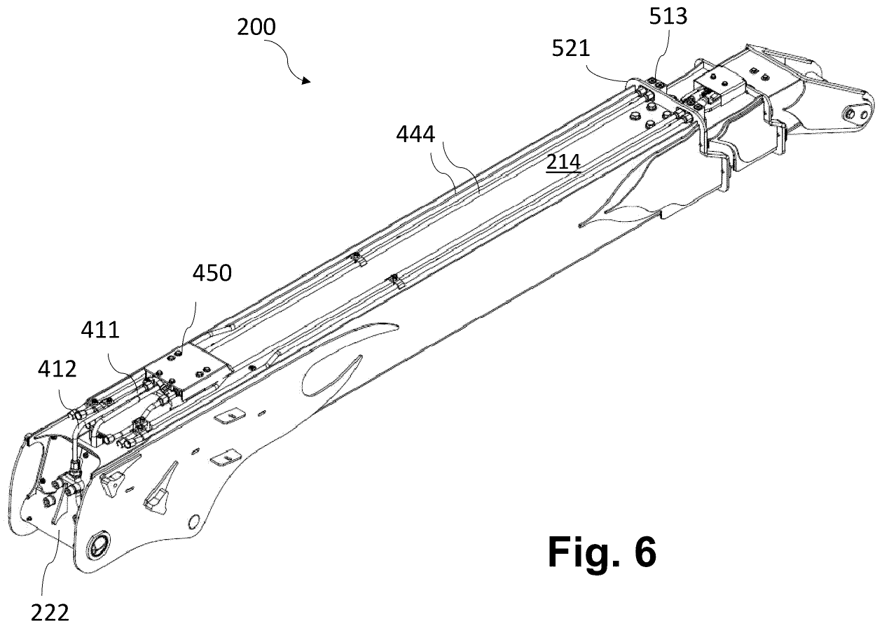

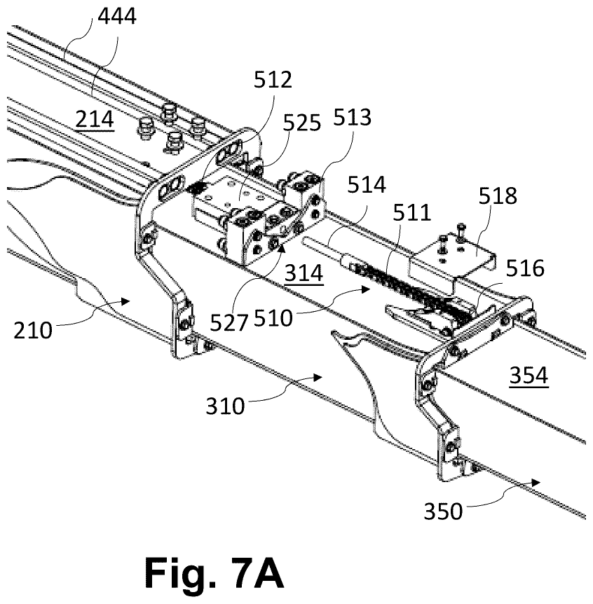

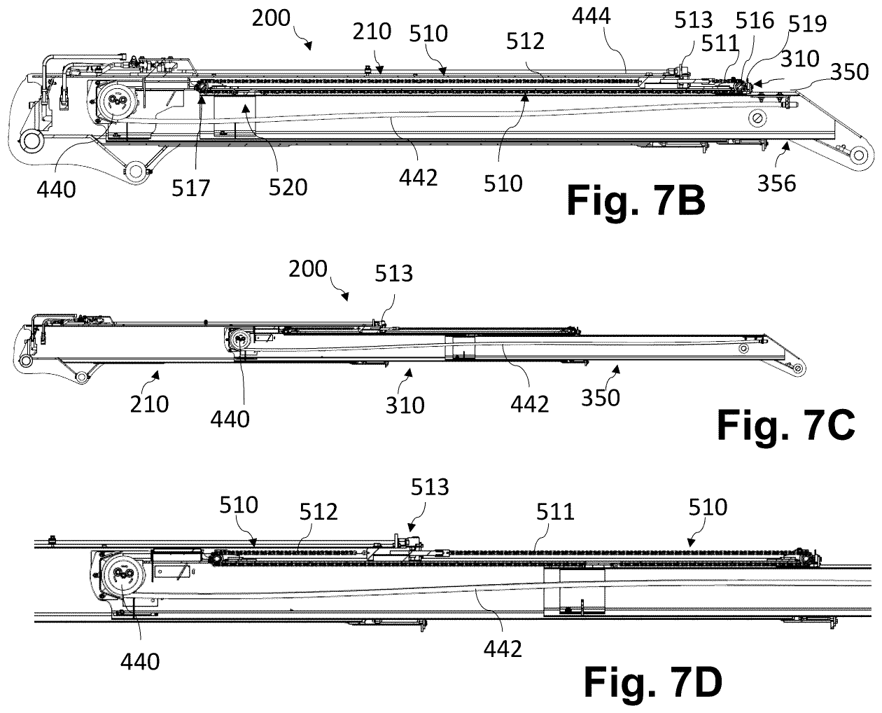

The jib assembly 200 has hydraulic inner hoses 442 (also referred to herein as the “hoses” or “hydraulic hoses 442”) and hydraulic outer tubes 444 (also referred to herein as “outer tubes 444”) depicted in FIGS. 5, 6, 8A, 8C. The outer tubes 444 are attached to the outer external surface 214 of the outer section 210 (in other terms, the outer external surface 214 of the outer body 211) and to the tensioner bulkhead block 513 (see, for example, FIGS. 5 and 6), which is attached to a contour plate of the outer section 210, while the inner hoses 442 are also attached to the tensioner bulkhead block 513 below the outer external surface 214 of the outer body 211 and then extend inside the outer section 210, between the outer section 210 and the middle section 310 (the middle external surface 314 of the middle section 310) to roll over the the hose rollers 440 and then to extend inside the inner section 350 and to attach to the tip portion 356 of the inner section 350 (as depicted in FIGS. 7B, 7C). The outer tubes 444 are preferably hard tubes, because hoses would need protection from damage when located outside of the jib assembly 200.

The hydraulic hoses 442 and outer tubes are configured to transfer the hydraulic fluid working pressure and flow to the grapple 130, to help performing such functions as opening, closing and rotating clockwise and/or counterclockwise of the grapple 130. The hose rollers 440 and hose tensioners 443 keep the hydraulic hoses 442 from tangling during retraction (during the execution of the retraction operation) of the jib assembly 200, and preventing stretching and breaking of the hoses 442 during the extending (during the execution of the extension operation) of the jib assembly 200.

The hose rollers 440 may be made from a composite material such as, for example, an acetal plastic, or similar materials, providing lower friction coefficient. The hydraulic hoses 442 as described herein may have a material that can provide a sliding contact (rated for sliding contact). The hydraulic hoses 442 may be made, for example, of polyethylene and are hard coated. Although the cost of such hydraulic hoses 442 may be higher than the cost of hoses used in prior art, the hydraulic hoses 442 as described herein use less grease, and, therefore, the jib assembly 200 is cleaner (less messy) during the service and maintenance.

The hose rollers 440 are sized to fit, together with the hydraulic hoses 442 inside the middle section 310, as illustrated, for example, in FIGS. 3 and 7B. The hose rollers 440 are configured to allow the hydraulic hoses 442 (which are also depicted in FIGS. 7B-7D) to roll over the hose rollers 440 when the jib assembly 200 extends to its extended position, and to pull the hydraulic hoses 442 inside the middle section 310, between the middle section 310 and the outer section 210. In at least one embodiment, the pair of hose rollers 440 are removably attached inside the middle section 310 to each one of two opposite middle section side walls. In at least one embodiment, the hose rollers 440 are configured to roll the hydraulic hoses 442 into the inner section 350 and the middle section 310 when the jib assembly 200 extends and retracts. In at least one embodiment, a sum of a first distance and a second distance remains constant during the operation of the jib assembly 200 (jib's extension and jib's retraction), the first distance being between hydraulic return manifolds 513 and the hose rollers 440, and the second distance being between the hose rollers 440 and a sliding tensioner bulkhead plate 520. The sum of the first distance and second distance may be referred to as “a distance between the hydraulic return manifolds 513, the hose rollers 440, and sliding tensioner bulkhead plate 520 attached to the inner section 350”.

FIG. 7A illustrates a portion of the middle section 310, in accordance with at least one embodiment. In at least one embodiment, the timing chain 510 is attached to the tensioner bulkhead block 513 which is attached to the outer section 210 (via a chain tensioner bolt 514) and to an extreme external surface 354 of the inner section 350. The timing chain 510 is configured to extend inside and outside of the middle section 310. In at least one embodiment, the timing chain 510 is removably attached to the outer section 210 and to the extreme external surface of the inner section 350, such that, when the stroke cylinder 400 is activated, and the stroke cylinder 400 extends the inner section 350 and the middle section 310 from the outer section 210, the timing chain 510 synchronizes simultaneous extension of the inner section 350 and the middle section 310 from the outer section 210. The timing chain 510 may pass through chain apertures 519 in the middle section 310 to extend inside and outside of the middle section 310 along one side of the middle section 310.

As can be seen in FIG. 7A, the jib assembly 200 comprises a first timing chain portion 511 of a timing chain 510. The first timing chain portion 511 is connected to the tensioner bulkhead block 513 via a chain tensioner bolt 514. The chain tensioner bolt 514 is removably attached to the tensioner bulkhead block 513 and can be fully unscrewed therefrom for the service and/or partially unscrewed and screwed back to adjust the tension of the timing chain 510.

The timing chain 510 is also connected to a chain roller 516 attached to the middle external surface 314 of the middle section 310, the chain roller 516 is covered by a chain roller cover 518.

The timing chain 510 also has a second timing chain portion 512 attached to the tensioner bulkhead block 513 on the other side from the first timing chain portion 511, as illustrated in FIGS. 7A-7D.

FIGS. 7B, 7C, 7D illustrate partial cross-sectional views of the jib assembly 200 depicting different positions and the performance of the timing chain 510, in accordance with at least one embodiment. FIG. 7B illustrates the jib assembly 200 in a retracted position. FIG. 7C illustrates the jib assembly 200 in an extended position. FIG. 7D illustrates an enlarged portion of FIG. 7C, depicting the timing chain 510.

The timing chain 510 is used in the jib assembly 200 for synchronizing the “timing” of the extending the inner section 350 from the middle section 210. In other words, when the stroke cylinder 400 is activated and extends the inner section 350 and the middle section 310 from the outer section 210, the timing chain 510 synchronizes simultaneous move of the inner section 530 from the inside of the middle section 310 and move of the middle section 310 out from the inside of the outer section 210. Similarly, the timing chain 510 synchronizes simultaneous move of the inner section 530 back into of the middle section 310 and move of the middle section 310 back into the outer section 210. In other words, the timing chain 510 is used to extend the jib assembly 200 by moving both jib sections (inner section 350 and middle section 310) out of the outer section 210 simultaneously (at the same time) and to retract the jib assembly 200 by moving both jib sections (inner section 350 and middle section 310) back into the outer section at the same time.

As illustrated in FIGS. 7B-7D, the timing chain 510 is removably attached to tensioner bulkhead block 513 which is attached to the outer section 210. The timing chain 510 slides around the chain rollers 516, 517 (which may be also referred to as “timing chain rollers”) attached to the middle external surface 314 of the middle body 311 of the middle section 310 and slides on the internal and external sides of the middle body 311 of the middle section 310. The chain rollers 516, 517 are attached to the middle section 310 and configured to assist rolling of the timing chain 510. In at least one embodiment, the timing chain 510 may be attached to the inner section 350 at the inner section chain attachment point 520 (also referred to as “sliding tensioner bulkhead plate 520”) located on the extreme external surface 354 of the inner body 351 of the inner section 350.

During the operation of the jib assembly 200 (jib's extension and jib's retraction), the distance between the hydraulic return manifolds 513, the hose rollers 440, and the sliding tensioner bulkhead plate 520 attached to the inner section 350 remains constant. The timing chain 510 is attached to a chain attachment block 525 removably attached to the outer section 210. The chain attachment block 525 is an attachment block for chain tensioning bars, hydraulic return manifolds, and bolt-on covers. In at least one embodiment, the chain attachment block 525 is attached to hydraulic return manifolds 513 (also referred to herein as “tensioner bulkhead block 513” or “hose bulkhead 513”) by a connecting plate 527. For example, as illustrated in FIG. 7A, the connecting plate 527 may be bolted to the chain attachment block 525 with larger bolts, then left and right hydraulic return manifolds 513 are bolted to the connecting plate 527 with smaller bolts.

The timing chain 510 helps preventing the middle section 310 and the inner section 350 moving independently of each other, that could have resulted in hydraulic hoses 442 getting loose during the retraction operation of the jib assembly 200, which would be undesirable, and could lead to tangling and falling off the hose rollers 440.

The timing chain 510 as described herein does not carry the full load, and therefore the timing chain 510 as used in the jib assembly 200 as described herein can be smaller, lighter, and/or less expensive than chains used in the prior art. The timing chain 510 and the internal hydraulic hoses 442 of the jib assembly 200 as described herein do not require complex assembly and maintenance.

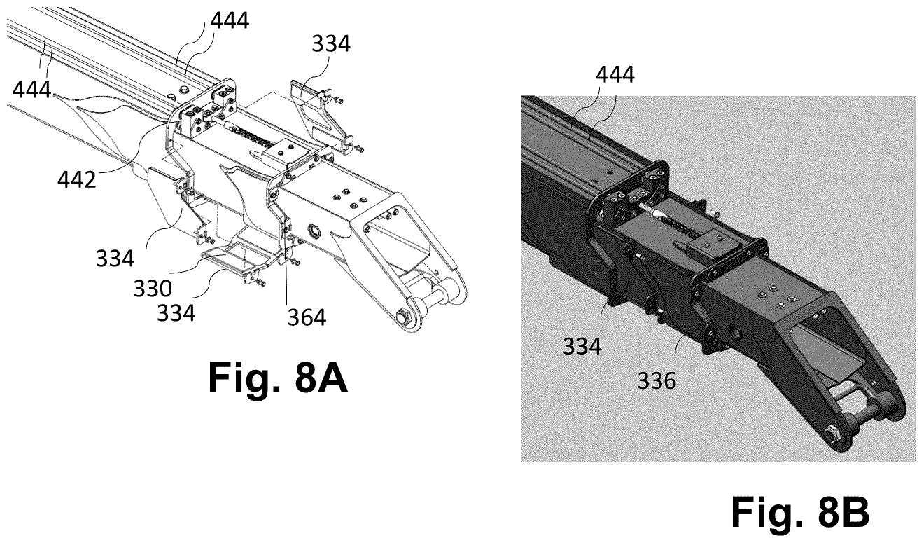

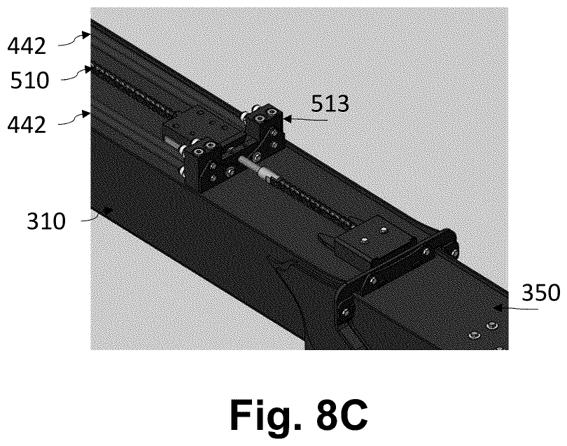

In at least one embodiment, the jib assembly 200 has a set of sliding wear pads 330, 360 illustrated in FIG. 4A. Outer wear pads 330 are positioned in recesses 332 of outer slider pad trays 334 (better visible in FIGS. 8A and 8B) that are configured to restrict movement of the outer wear pads 330 while providing a functionality of a spacing cushion (which may be also referred to as a spacer) between the internal surface 215 of the outer section 210 and the middle external surface 314 of the middle section 310 due to the outer wear pads 330 being thicker than the depth of the recesses 332 in the outer slider pad trays 334. Each wear pad 330 has a length and width to fit in its respective recess 332 in the outer slider pad tray 334 and to partially extend beyond its respective outer slider pad tray 334 and thus provide a cushion between the outer slider pad tray 334 and the middle external surface 314 of the middle section 310.

Similarly, inner wear pads 360 are positioned between the inner section 350 and the middle section 310. The inner wear pads 360 are located in inner slider pad trays 364 which are removably attached to the middle section 310 (see FIGS. 4A, 8A). Similarly to the outer wear pads 330 located between the outer section 310 and the middle section 310, the inner wear pads 360 are located between the inner section 350 and the middle section 310 and are configured to provide a functionality of a spacing cushion (which may be also referred to as a spacer) between the middle section 310 and the extreme external surface 354 of the inner section 350 due to the inner wear pads 360 being thicker than the depth of the recesses 332 in the inner slider pad trays 336.

The jib assembly 200 comprises a plurality of outer wear pads positioned between the outer section and the middle section (which may permit to provide/ensure an equal spacing between the outer section and the middle section) and a plurality of inner wear pads positioned between the inner section and the middle section (which may permit to provide/ensure an equal spacing between the inner section and the middle section). The outer wear pads are positioned between the outer section 210 and the middle section 310 to provide/ensure and equal spacing between the outer section and the middle section and the inner wear pads are positioned between the inner section 350 and the middle section 310 to provide/ensure and equal spacing between the inner section 350 and the middle section 310.

FIGS. 8A and 8B illustrate partial exploded views of the tip portion of the jib assembly 200 illustrating the outer slider pad trays 334 which are removably attached to the outer section 210 and are located, at least partially, inside the outer body 211 (in other terms, the hollow body of the outer section 210), between the outer section 210 and the middle section 310. The outer slider pad trays 334 are located between the internal surface 215 of the outer section 210 and the middle external surface 314 of the middle section 310. Similarly, the inner slider pad trays 336 are located between the internal surface 355 of the middle section 310 and the extreme external surface 354 of the inner section 350.

The sliding wear pads 330, 360 are made of a material that improves the loading and speed and may help to manipulate and bear high loads and high-speed operation by the jib assembly 200. The sliding wear pads 330, 360 may be made of, for example, and preferably, nylon. The sliding wear pads 330, 360 are wear-resistant due to the materials used, such as nylon (for example, Mitsubishi Advanced Chemical proprietary chemistry), and self-lubrication, to withstand fast speeds of extension of the jib assembly 200.

The sliding wear pads 330, 360 (the outer wear pads and the inner wear pads) are impregnated with a lubricator and are impact resistant. For example, the sliding wear pads 330, 360 may be made of a cast material impregnated with a solid lubricant. For example, the sliding wear pads 330, 360 may be made of Nylatron 703XL. Such sliding wear pads 330, 360 are therefore self-lubricating and, due to this quality of self-lubrication of the sliding wear pads 330, 360, the jib assembly 200 does not need additional greasing. It other terms, in at least one embodiment, the jib assembly 200 as described herein uses the lube-impregnated impact-resistant nylon wear pads.

The sliding wear pads 330, 340, 360 used in the jib assembly 200 permit reducing the amount of grease used in the jib assembly 200. Significantly higher amounts of grease would need to be used in prior art jibs to improve their speed and loading efficiency.

In at least one embodiment, the jib assembly 200 has a set of shims. The shims fit behind the wear pads 330, 340, 350, 360. The shims may be used optionally. The shims allow for initial adjustment of fit between mating sections (the outer section 210, the middle section 310, the inner section 350) due to manufacturing variance. Shims may also allow for less critical, lower cost manufacturing instead of tight tolerance manufacturing.

In at least one embodiment, the jib extension assembly 300 may have more than two jib extensions (sections). For example, the jib extension assembly 300 may have one or more middle jib extension 310 or more than two middle sections 310.

In at least one embodiment, the middle body 311, the outer body 211 and/or the inner body 351 of the jib assembly 200 are preferably each manufactured from only two plates of steel, where the top plate is flat, and the bottom plate has three bends. Thus, the middle body 311, the outer body 211 and/or the inner body 351 may be made of two sheets of material and may have only two weld joints located between the respective top surface and the sides of the jib extension structure, which makes manufacturing easier and reduces the cost of the jib assembly 200. Known prior-art boom extension structure is made of four plates (top, bottom, and two sides), thus having four weld joints. In some embodiments, the middle body 311, the outer body 211 and/or the inner body 351 of the jib assembly 200 as described herein may be made of more than two plates (for example, four plates) and therefore more than two weld joints (for example, four weld joints), although such jib assembly 200 may be more expensive and complicated to make.

The elements of the jib assembly 200 as discussed herein are removably attached to each other in order to be able to dismantle the jib assembly 200 and to reach the inner elements of the jib assembly 200 for replacement and service.

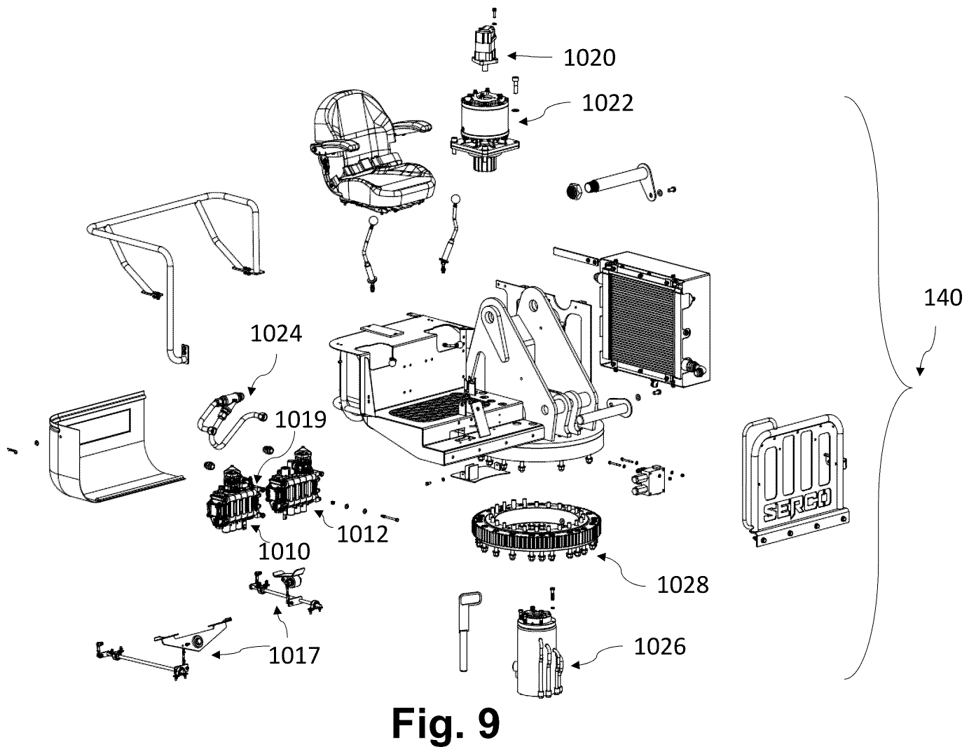

FIG. 9 illustrates a perspective exploded view of a managing assembly 140 for operation of the knuckle boom loader with the jib assembly of FIG. 3, in accordance with at least one embodiment of the present disclosure. In the jib assembly 200, the hydraulic control valves 1010, 1012 (also referred to herein as “main control valves 1010, 1012” or “main valves”) are used as main control. The main valves 1010, 1012 (which may be also referred to as “valve banks 1010, 1012”) have a different combination of valve sections compared to prior art valves. A combination of a swing bearing, a pinion, a gearbox, and hydraulic motors may be determined based on a target loader spinning speed (RPM or revolutions per minute) and swing torque. A rotation hydraulic motor 1020 is configured to operate the jib assembly 200 at faster swing speeds compared to the prior art, and is different from motors used in prior art jibs. For example, the hydraulic motor 1020 may be 4.9 Cl. The managing assembly 140 may also comprise a gearbox and a pinion 1022, a hydraulic return 1024, a 7-port manifold 1026, depicted in FIG. 9.

The main valves 1010, 1012 may be, for example, a first valve 1010 and a second valve 1012. The first valve 1010 may be, for example, a hydrocontrol 4-spool jib valve, and the second valve may be, for example, a 4-spool main valve.

To perform swing functions, the following components may be used: a slewing bearing or a rotation bearing 1028 illustrated in FIG. 9; the gearbox and the pinion 1022; the rotation hydraulic motor 1020; actuator pedals 1017; as well as hydraulic supply, return, and extra valves for swing stabilization. Each one of the valve banks 1010, 1012 may have multiple control sections for cylinders and rotation motors. A swing valve section 1019 in the first valve bank 1010, which is the closest section to the second valve bank 1012 in FIG. 9, is used for the swing function.

The jib assembly 200 is operatively connected to the regenerative valve 450, and the regenerative valve 450 is operated by the main control valve 1010, 1012. In at least one embodiment, the jib assembly 200 is operated by the hydraulic regenerative valve operated by the main control valve.

The regenerative valve 450 recycles return the oil in order to accelerate extension of the jib assembly 200 to the extended state (also referred to as an “extend cycle”). The regenerative valve 450 allows to increase flow rate of the single extend a cylinder 400. Compared to the prior art systems, the cylinder flow rate of the jib assembly 200 as described herein may be higher.

The regenerative valve 450 may provide faster valve cylinder extension speeds by taking the oil from the rod end of the cylinder 400 and diverting it to the head end of the cylinder. This means that the effective area during the extend cycle of the jib assembly 200 is the area of the rod of the cylinder area that provides a faster speed but also a reduced force. For example, due to using the regenerative valve 450, the extension speed (speed of extending the jib assembly from the retracted position to the extended position) of the jib assembly 200 may be increased. For example, an extend rate may be increased from 19.45 inches per second (in/sec) to 36.76 in/see (0.49 meters/see to 0.934 meters/sec). For example, time to extend the full 104 inches (2.64 meters) of the jib assembly 200 without regeneration may be 5.35 sec, while with regeneration may be 2.83 sec. Such regenerative valves 450 were not used in prior art jibs because the prior art appear to not be using any long stroke jib extension cylinders.

The stroke cylinder 400 as described herein is longer than the cylinders used in the prior art jibs, and the speed of the operation of the shorter stroke cylinder used in the prior art and therefore the speed of the operation of the prior art jibs depends on the heavy-duty chain system.

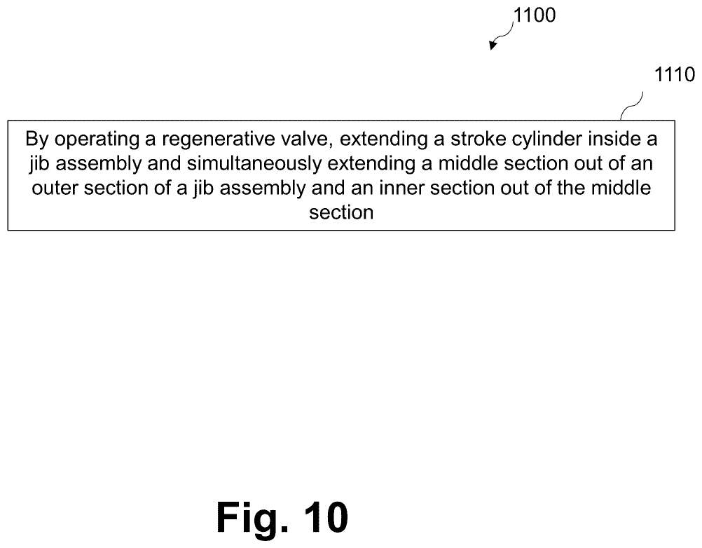

FIG. 10 illustrates a method 1100 of operation of a jib assembly 200. The method 1100 comprises, at step 1110, by operating the regenerative valve 450, extending the stroke cylinder 400 inside a jib assembly 200 and simultaneously extend a middle section 310 out of an outer section 210 of a jib assembly 200 and an inner section 350 out of the middle section 310. In at least one embodiment, the extension of the middle section 310 out of the outer section 210 of the jib assembly 200 and the inner section 350 out of the middle section 310 is timed by the timing chain 510 extending inside and outside of the middle section 310, the timing chain 510 being attached to the outer section 210. The method of operating the jib assembly may comprise, by operating the regenerative valve 450, retracting the stroke cylinder 400 inside the jib assembly 200 and simultaneously retracting the middle section 310 into the outer section 210 of the jib assembly 200 and the inner section 350 into the middle section 310. In at least one embodiment, the retraction of the middle section 310 into the outer section 210 of the jib assembly 200 and the inner section 350 into the middle section 310 is timed by the timing chain 510 extending inside and outside of the middle section 310, the timing chain 510 being attached to the outer section 210.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A jib assembly comprising:
an outer section having a hollow outer body;
a middle section having a hollow middle body and positioned coaxially with the outer section and located partially inside the outer section;
an inner section having a hollow inner body and positioned coaxially with the middle section, and located partially inside the middle section; and
a stroke cylinder having a cylinder base and a piston end, the cylinder base of the stroke cylinder being connected to a base wall of the outer section and the piston end being connected to a tip portion of the inner section, and
the stroke cylinder being configured to move simultaneously the inner section from inside of the middle section and to move the middle section from inside of the outer section.

2. The jib assembly of claim 1, wherein the stroke cylinder is operated by a regeneration valve located on an outer external surface of the outer section, the regeneration valve being connected to the stroke cylinder via a first tube and a second tube.

3. The jib assembly of claim 1, wherein the stroke cylinder is operated by a regeneration valve being attached directly to the stroke cylinder or integral to cylinder hydraulic ports.

4. The jib assembly of claim 1, configured to be operated by a hydraulic regenerative valve operated by a main control valve.

5. The jib assembly of claim 1, wherein the piston end is connected to the tip portion of the inner section using a piston pin positioned perpendicular to the stroke cylinder.

6. The jib assembly of claim 1, further comprising a pair of hose rollers removably attached inside the middle section to each one of two opposite middle section side walls, the hose rollers being configured to roll hydraulic hoses into the inner section and the middle section when the jib assembly extends and retracts, and a sum of a first distance and a second distance remains constant during extension and retraction of the jib assembly, the first distance being between hydraulic return manifolds and the hose rollers, and the second distance being between the hose rollers and a sliding tensioner bulkhead plate.

7. The jib assembly of claim 1, further comprising hydraulic outer tubes attached to the outer external surface of the outer body and to a tensioner bulkhead block; and inner hoses attached to the tensioner bulkhead block on the other side and then extend inside the outer section, between the outer section and the middle section to attach to a tip portion of the inner section.

8. The jib assembly of claim 1, further comprising a timing chain removably attached to the outer section and to an extreme external surface of the inner section, such that, when the stroke cylinder is activated, and the stroke cylinder extends the inner section and the middle section from the outer section, the timing chain synchronizes simultaneous extension of the inner section and the middle section from the outer section.

9. The jib assembly of claim 8, wherein the timing chain passes through chain apertures in the middle section to extend inside and outside of the middle section along one side of the middle section.

10. The jib assembly of claim 9, wherein the timing chain is attached to a chain attachment block removably attached to the outer section.

11. The jib assembly of claim 8, further comprising chain rollers attached to the middle section and configured to assist rolling of the timing chain.

12. The jib assembly of claim 1, wherein cross-sections of the outer section, the middle section and the inner section are rectangular.

13. The jib assembly of claim 12, wherein the outer section, the middle section and the inner section each are made of two sheets of material and have two weld joints.

14. The jib assembly of claim 1, further comprising:
a plurality of outer wear pads positioned between the outer section and the middle section and
a plurality of inner wear pads positioned between the inner section and the middle section.

15. The jib assembly of claim 14, wherein the outer wear pads and the inner wear pads are impregnated with a lubricator and are impact resistant.

16. The jib assembly of claim 14, wherein the outer wear pads are located in recesses located in outer slider pad trays attached to sides of the outer section, and the inner wear pads are located in other recesses in inner slider pad trays attached to sides of the middle section.

17. A knuckle boom loader comprising the jib assembly of claim 1.

18. A method comprising:
by operating a regenerative valve, extending a stroke cylinder inside a jib assembly and simultaneously extending a middle section out of an outer section of the jib assembly and an inner section out of the middle section.

19. The method of claim 18, wherein the extension of the middle section out of an outer section of a jib assembly and an inner section out of the middle section is timed by a timing chain extending inside and outside of the middle section, the timing chain being attached to the outer section.

20. A method comprising:
by operating a regenerative valve, retracting a stroke cylinder inside a jib assembly and simultaneously retracting a middle section into an outer section of the jib assembly and an inner section into the middle section.
